(19) United States
(12) Patent Application Publication
(10) Pub. No.: US 2012/0246223 A1
(43) Pub. Date: Sep. 27, 2012

(54) SYSTEM AND METHOD FOR DISTRIBUTING VIRTUAL AND AUGMENTED REALITY SCENES THROUGH A SOCIAL NETWORK

(76) Inventors: BENJAMIN ZEIS NEWHOUSE, SAN FRANCISCO, CA (US); TERRENCE EDWARD MCARDLE, SAN FRANCISCO, CA (US)

(21) Appl. No.: 13/411,314

(22) Filed: Mar. 2, 2012

Related U.S. Application Data
(60) Provisional application No. 61/448,322, filed on Mar. 2, 2011.

(51) Int. Cl. G06F 15/16

(52) U.S. Cl. 709/203

(57) ABSTRACT

A preferred method for distributing virtual and augmented reality (VAR) scenes between users and viewers through a social network can include delivering one or more VAR scene parameters to a server and requesting a VAR scene from the server at which the VAR scene is hosted. The VAR scene can include both visual data and orientation data, and the orientation data can include at least a real orientation of a device relative to a projection matrix. The preferred method described herein can further include receiving the VAR scene from the server at a viewer device in response to the one or more VAR scene parameters.

### CLAIM OF PRIORITY

The present application claims priority to U.S. Provisional Patent Application Ser. No. 61/448,322 filed on 2 Mar. 2011 and entitled “Method for Discovering Virtual and Augmented Reality Scenes,” the entirety of which is incorporated herein by this reference.

### TECHNICAL FIELD

This invention relates generally to the virtual and augmented reality field, and more specifically to a new and useful system and method for distributing virtual and augmented reality scenes through a social network.

### BACKGROUND AND SUMMARY

Recent years have seen a rise in the capability to create and/or view augmented reality on mobile devices. Likewise, media sharing has become more widespread and easier due to access to mobile devices and social networks. These media sharing tools generally focus on photos and videos. In these forms of media, the user is generally passive; there is little active participation when viewing the media. The capability to view augmented reality on mobile devices has been increasing in recent years. However, discovering and exploring virtual and augmented reality scenes is more difficult. Each virtual and augmented reality scene requires user participation, and user dissatisfaction will be increased when an uninteresting scene is explored. Thus, there is a need in the virtual and augmented reality field to create a new and useful method for discovering virtual and augmented reality scenes. This invention provides such a new and useful system and/or method, the details of which are described below in its preferred embodiments with reference to the following drawings.

### BRIEF DESCRIPTION OF THE FIGURES

FIG. 1 schematic diagram of a system and method for distributing VAR scenes through a social network in accordance with preferred embodiments of the present invention.

FIG. 2 is a schematic representation of a preferred device, system, and/or operating environment of a mobile device in accordance with the system and method of the preferred embodiments.

FIG. 3 is a schematic view of a user or viewer interacting with a mobile device in accordance with the system and method of the preferred embodiments.

FIGS. 4A to 4M are schematic representations of a VAR scene being adjusted on a mobile device in accordance with the system and method of the preferred embodiments.

FIG. 5 is a schematic diagram of a system and method for distributing VAR scenes through a social network in accordance with variations of the preferred embodiments.

FIG. 6 is a flowchart depicting a method of distributing VAR scenes through a social network in accordance with a preferred embodiment of the present invention.

FIG. 7 is a flowchart depicting a method of distributing VAR scenes through a social network in accordance with a variation of the preferred embodiment of the present invention.

FIG. 8 is a flowchart depicting a method of distributing VAR scenes through a social network in accordance with another variation of the preferred embodiment of the present invention.

FIG. 9 is a flowchart depicting a method of distributing VAR scenes through a social network in accordance with another variation of the preferred embodiment of the present invention.

FIG. 10 is a flowchart depicting a method of distributing VAR scenes through a social network in accordance with another preferred embodiment of the present invention.

FIG. 11 is a flowchart depicting a method of distributing VAR scenes through a social network in accordance with another variation of the preferred embodiment of the present invention.

FIG. 12 is a flowchart depicting a method of distributing VAR scenes through a social network in accordance with another preferred embodiment of the present invention.

FIG. 13 is a flowchart depicting a distributing VAR scenes through a social network in accordance with another variation of the preferred embodiment of the present invention.

FIG. 14 is a flowchart depicting a method of distributing VAR scenes through a social network in accordance with another variation of the preferred embodiment of the present invention.

FIG. 15 is a flowchart depicting a method of distributing VAR scenes through a social network in accordance with another variation of the preferred embodiment of the present invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Systems

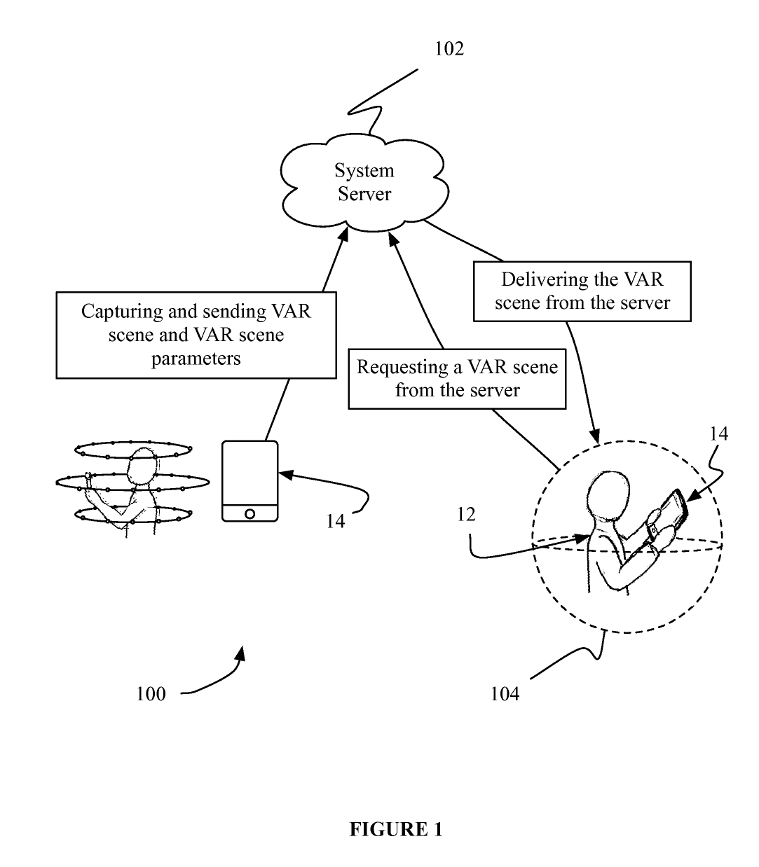

As shown in FIG. 1, a system 100 of the preferred embodiment can include a user device 14, a viewer device 14, and a system server 102. A preferred server 102 can include a server 102 used in a social network for distributing virtual and augmented reality (VAR) scenes between users and viewers. As used herein, the user device 14 and the viewer device 14 are defined in terms of the function being performed by the respective user/viewer, and each type of device 14 is interchangeable with the other as described herein depending upon the use the device 14 is being put to by the user/viewer. The preferred user device 14 can be used by a user to capture, process, create, and/or generate a viewable scene, such as for example a VAR scene. The preferred viewer device 14 can be used by a viewer to receive, process, orient, render, generate, and/or view a viewable scene, such as for example a VAR scene.

Preferably, the user device 14 and the viewer device 14 are substantially similar. One or both of the user device 14 and the viewer device 14 can include one or more cameras (front/rear), an accelerometer, a gyroscope, a MEMS gyroscope, a magnetometer, a pedometer, a proximity sensor, an infrared sensor, an ultrasound sensor, a global position satellite transceiver, WiFi transceiver, mobile telephone components, and/or any suitable combination thereof for calculating a projection matrix and/or the associated Euler angles. In the user device 14 and/or the viewer device 14, orientation and/or position information can be gathered in any suitable fashion, including device Application Programming Interfaces (API) or through any suitable API exposing device information, e.g., using HTML5 to expose device information including orientation/location.

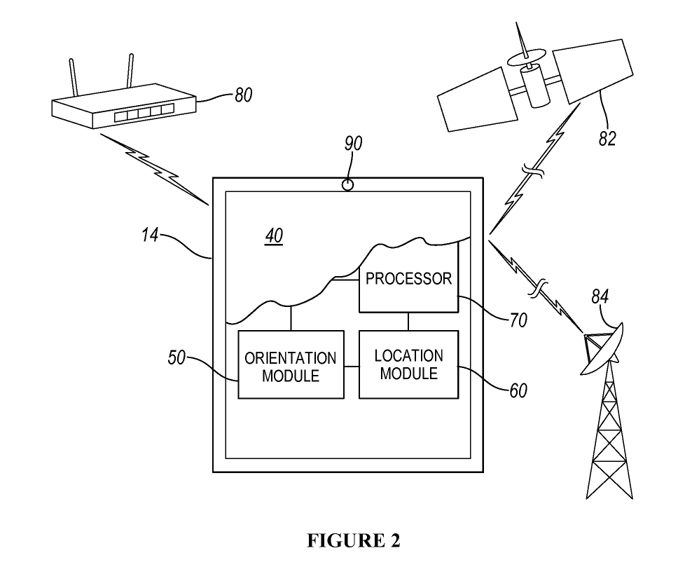

As shown in FIG. 2, the (user and/or viewer mobile) device 14 of the preferred embodiment can include a display 40, an orientation module 50 including a real orientation module and a user orientation module, a location module 60, a camera 90 oriented in substantially the same direction as the display 40, and a processor 70 connected to each of the display, orientation module 50, location module 60, and camera 90. The device 14 of the preferred embodiment preferably functions to capture and/or present a VAR scene to a user from the point of view of a nodal point or center thereof, such that it appears to the user that he or she is viewing the world (represented by the VAR scene) through a frame of a window. The device 14 of the preferred embodiment can include any suitable type of mobile computing apparatus such as a smart phone, a personal computer, a laptop computer, a tablet computer, a television/monitor paired with a separate handheld orientation/location apparatus, or any suitable combination thereof.

As shown in FIG. 2, the orientation module 50 of the device 14 of the preferred embodiment includes at least a real orientation portion and a user orientation portion. The real orientation portion of the orientation module 50 preferably functions to provide a frame of reference for the device 14 as it relates to a world around it, wherein the world around can include real three dimensional space, a virtual reality space, an augmented reality space, or any suitable combination thereof. As noted below, the projection matrix can preferably include a mathematical representation of an arbitrary orientation of a three-dimensional object (i.e., the device 14) having three degrees of freedom relative to a second frame of reference. As noted in the examples below, the projection matrix can include a mathematical representation of the device 14 orientations in terms of its Euler angles (pitch, roll, yaw) in any suitable coordinate system.

In one variation of the device 14 of the preferred embodiment, the second frame of reference can include a three-dimensional external frame of reference (i.e., real space) in which the gravitational force defines baseline directionality for the relevant coordinate system against which the absolute orientation of the device 14 can be measured. In such an example implementation, the device 14 will have certain orientations corresponding to real world orientations, such as up and down, and further such that the device 14 can be rolled, pitched, and/or yawed within the external frame of reference. Preferably, the orientation module 50 can include a MEMS gyroscope configured to calculate and/or determine a projection matrix indicative of the orientation of the device 14. In one example configuration, the MEMS gyroscope can be integral with the orientation module 50. Alternatively, the MEMS gyroscope can be integrated into any other suitable portion of the device 14 or maintained as a discrete module of its own.

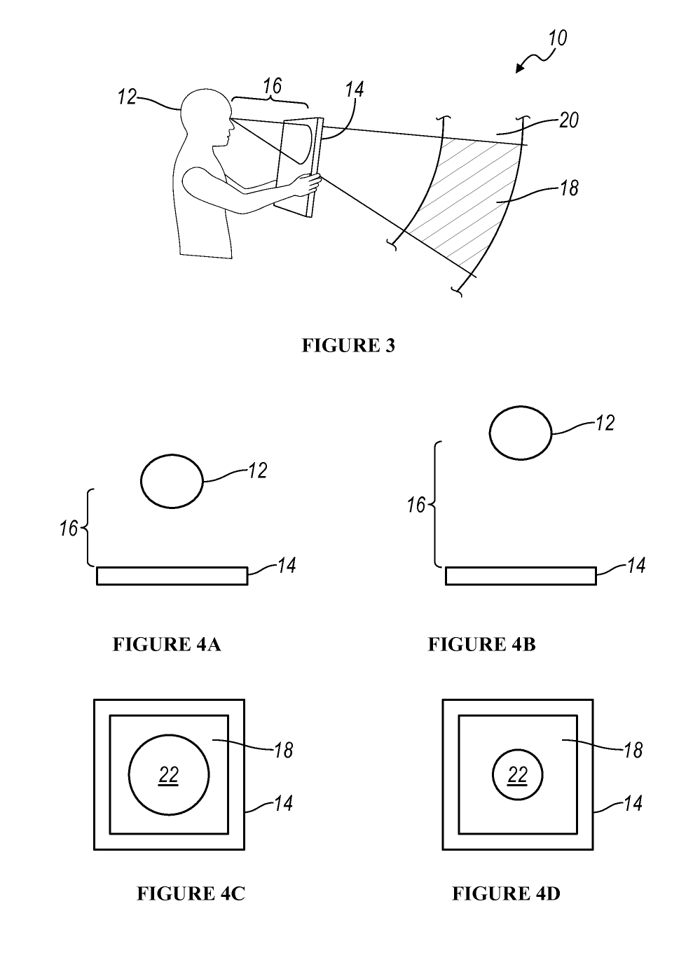

As shown in FIG. 2, the user orientation portion of the orientation module 50 preferably functions to provide a frame of reference for the device 14 relative to a point or object in space, including a point or object in real space. Preferably, the user orientation can include a measurement of a distance and/or rotational value/s of the device relative to a nodal point. In another variation of the device 14 of the preferred embodiment, the nodal point can include a user's head such that the user orientation includes a measurement of the relative distance and/or rotational value/s of the device 14 relative to a user's field of view. Alternatively, the nodal point can include a portion of the user's head, such as for example a point between the user's eyes. In another alternative, the nodal point can include any other suitable point in space, including for example any arbitrary point such as an inanimate object, a group of users, a landmark, a location, a waypoint, a predetermined coordinate, and the like. Preferably, as shown in FIG. 3, the user orientation portion of the orientation module 50 can function to create a viewing relationship between a viewer 12 (optionally located at the nodal point) and the device 14, such that a change in user orientation can cause a consummate change in viewable content consistent with the user's VAR interaction, i.e., such that the user's view through the frame will be adjusted consistent with the user's orientation relative to the frame.

As shown in FIG. 2, one variation of the device 14 of the preferred embodiment includes a location module 60 connected to the processor 70 and the orientation module 50. The location module 60 of the preferred embodiment functions to determine a location of the device 14. As noted above, location can refer to a geographic location, which can be indoors, outdoors, above ground, below ground, in the air or on board an aircraft or other vehicle. Preferably, as shown in FIG. 2, the device 14 of the preferred embodiment can be connectable, either through wired or wireless means, to one or more of a satellite positioning system 82, a local area network or wide area network such as a WiFi network 80, and/or a cellular communication network 84. A suitable satellite position system 82 can include for example the Global Positioning System (GPS) constellation of satellites, Galileo, GLONASS, or any other suitable territorial or national satellite positioning system. In one alternative embodiment, the location module 60 of the preferred embodiment can include a GPS transceiver, although any other type of transceiver for satellite-based location services can be employed in lieu of or in addition to a GPS transceiver.

The processor 70 of the device 14 of the preferred embodiment functions to manage the presentation of the VAR scene to the viewer 12. In particular, the processor 14 preferably functions to display a scene to the viewer 12 on the display 40 in response to the real orientation and the user orientation. The processor 70 of the preferred embodiment can be configured to process, compute, calculate, determine, and/or create a VAR scene that can be displayed on the device 14 to a viewer 12, wherein the VAR scene is oriented to mimic the effect of the viewer 12 viewing the VAR scene as if through the frame of the device 12. Preferably, orienting the scene can include preparing a VAR scene for display such that the viewable scene matches what the user would view in a real three-dimensional view, that is, such that the displayable scene provides a simulation of real viewable space to the viewer 12 as if the device 14 were a transparent frame. As noted above, the scene is preferably a VAR scene; therefore it can include one or more virtual and/or augmented reality elements composing, in addition to, and/or in lieu of one or more real elements (buildings, roads, landmarks, and the like, either real or fictitious). Alternatively, the scene can include processed or unprocessed images/videos/multimedia files of one or more displayable scene aspects, including both actual and fictitious elements as noted above.

As shown in FIG. 3, in another variation of the device 14 of the preferred embodiment, the VAR scene can include a spherical image 20. Preferably, the portion of the spherical image (i.e., the VAR scene 18) that is displayable by the device 14 corresponds to an overlap between a viewing frustum of the device (i.e., a viewing cone projected from the device) and the imaginary sphere that includes the spherical image 20. The scene 18 is preferably a portion of the spherical image 20, which can include a substantially rectangular display of a concave, convex, or hyperbolic rectangular portion of the sphere of the spherical image 20. Preferably, the nodal point is disposed at approximately the origin of the spherical image 20, such that a viewer 12 has the illusion of being located at the center of a larger sphere or bubble having the VAR scene displayed on its interior. Alternatively, the nodal point can be disposed at any other suitable vantage point within the spherical image 20 displayable by the device 14. In another alternative, the displayable scene can include a substantially planar and/or ribbon-like geometry from which the nodal point is distanced in a constant or variable fashion. Preferably, the display of the scene 18 can be performed within a 3D or 2D graphics platform such as OpenGL, WebGL, or Direct 3D. Alternatively, the display of the scene 18 can be performed within a browser environment using one or more of HTML5, CSS3, or any other suitable markup language. In another variation of the device 14 of the preferred embodiment, the geometry of the displayable scene can be altered and/or varied in response to an automated input and/or in response to a user input.

In another variation of the device 14 of the preferred embodiment, the processor 70 can be further configured to adapt the scene displayable on the device 14 to the user 12 in response to a change in one of the real orientation or the user orientation. The processor 70 preferably functions to alter, change, reconfigure, recompute, regenerate, and/or adapt the displayable scene in response to a change in the real orientation or the user orientation in order to create a uniform and immersive user experience by adapting the displayable scene consistent with movement of the device 14 relative to the projection matrix and/or relative to the nodal point. Preferably, adapting the displayable scene can include at least one of the processor 70 adjusting a virtual zoom of the scene, the processor 70 adjusting a virtual parallax of the scene, the processor 70 adjusting a virtual perspective of the scene, and/or the processor 70 adjusting a virtual origin of the scene. Alternatively, adapting the displayable scene can include any suitable combination of the foregoing, performed by the processor 70 of the preferred embodiment substantially serially or substantially simultaneously, in response to a timing of any determined changes in one or both of the real orientation or the user orientation.

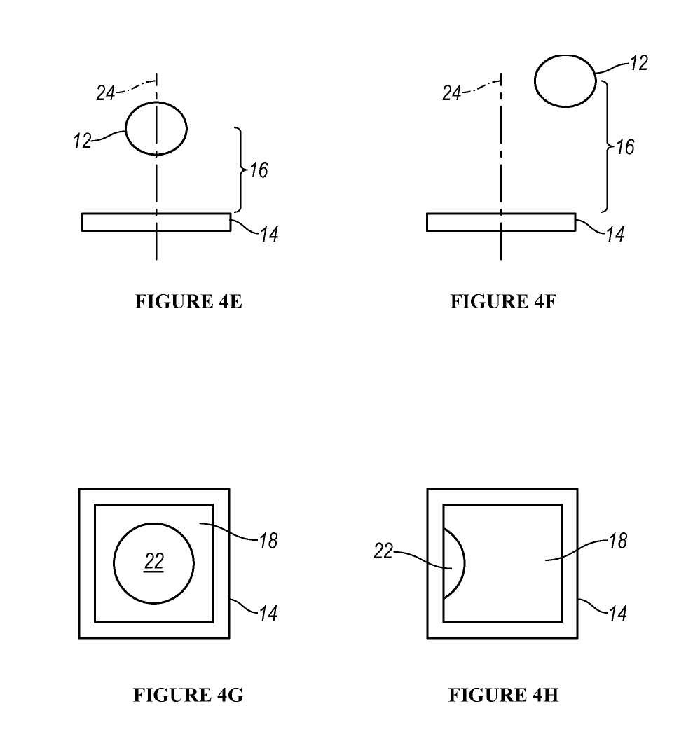

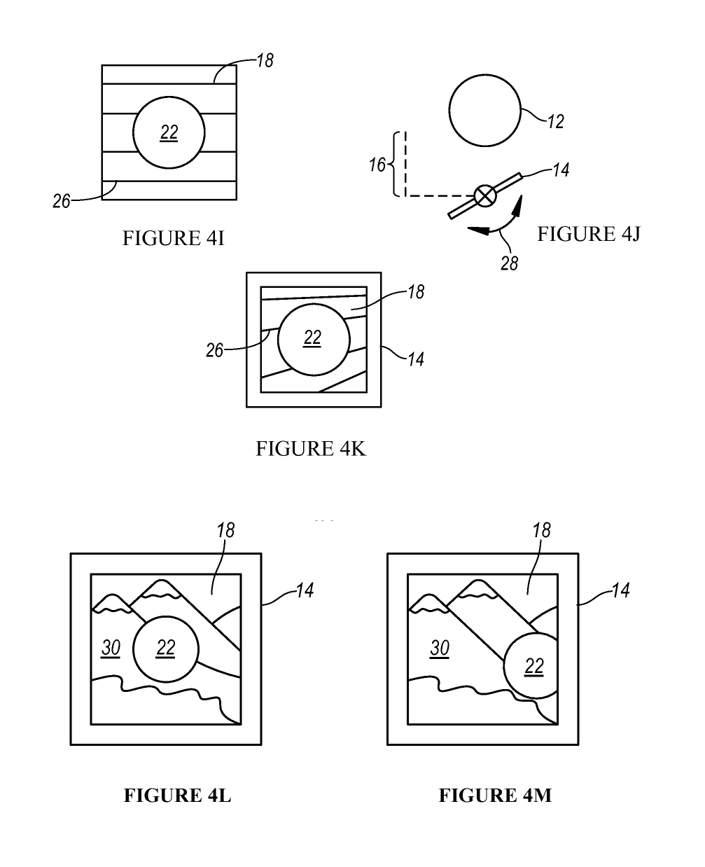

As shown in FIGS. 4A, 4B, 4C, and 4D, in one variation of the device 14 of the preferred embodiment, the processor is further configured to adjust a virtual zoom of the scene 18 in response to a change in a linear distance 16 between the device 14 and the nodal point 12. As shown in the FIGURES, the processor 70 of the preferred embodiment can be configured to alter a size of an aspect 22 of the scene 18 in response to an increase/decease in the linear distance 16 between the device 14 and the nodal point 12, i.e., the user's head. In another variation of the device 14 of the preferred embodiment, the device 14 can be configured to measure a distance 16 between the device 14 and the nodal point 12, which can include for example using a front facing camera 90 to measure the relative size of the nodal point 12 in order to calculate the distance 16. Alternatively, the adjustment of the virtual zoom can be proportional to a real zoom (i.e., a real relative sizing) of the nodal point 12 as captured by the device camera 90. As noted above, preferably as the distance decreases/increases, the size of the user's head will appear to increase/decrease, and the adjustment in the zoom can be linearly and/or non-linearly proportional to the resultant increase/decrease imaged by the camera 90. Alternatively, the distance 16 between the nodal point 12 and the device 14 can be measured and/or inferred from any other suitable sensor and/or metric, including at least those usable by the device 14 in determining the projection matrix as described above, including for example one or more cameras 90 (front/rear), an accelerometer, a gyroscope, a MEMS gyroscope, a magnetometer, a pedometer, a proximity sensor, an infrared sensor, an ultrasound sensor, and/or any module, portion, or component of the orientation module 50.

As shown in FIGS. 4E, 4F, 4G, and 4H, the processor 70 of the device of the preferred embodiment can be further configured to adjust a virtual parallax of the scene 18 in response to a change in a translational distance between the device 14 and the nodal point 12. As shown in FIG. 4F, movement of the device 14 relative to the nodal point 12 in a direction substantially perpendicular to imaginary line 24 can be interpreted by the processor 70 of the preferred embodiment as a request and/or input to move one or more aspects 22 of the scene 18 in a corresponding fashion. As shown in FIGS. 4L and 4M, the scene can include a foreground aspect 22 that is movable by the processor 70 relative to a background aspect 30. In another variation of the device 14 of the preferred embodiment, the processor 70 can be configured to identify one or more foreground aspects 22 and/or background aspects 30 of the displayable scene 18.

In another variation of the device 14 of the preferred embodiment, the processor 70 can be configured to measure a translational distance between the device 14 and the nodal point 12, which can include for example using a front facing camera 12 to measure the relative size and/or location of the nodal point 12 (i.e., the user's head) in order to calculate the translational distance. Alternatively, the translational distance between the nodal point 12 and the device 14 can be measured and/or inferred from any other suitable sensor and/or metric, including at least those usable by the device 14 in determining the projection matrix as described below, including for example one or more cameras 90 (front/rear), an accelerometer, a gyroscope, a MEMS gyroscope, a magnetometer, a pedometer, a proximity sensor, an infrared sensor, an ultrasound sensor, and/or any module, portion, or component of the orientation module 50.

Preferably, the translational distance is computed by the processor 70 as a function of both the size of the nodal point 12 (from the front facing camera 90) and a detection of a planar translation of the device 14 in a direction substantially orthogonal to the direction of the camera 90, thus indicating a translational movement without any corrective rotation. For example, one or more of the aforementioned sensors can determine that the device 14 is moved in a direction substantially orthogonal to the camera direction 90 (along imaginary line 24 in FIGS. 4E and 4F), while also determining that there is no rotation of the device 14 about an axis (i.e., axis 28 shown in FIG. 4J) that would direct the camera 90 radially inwards towards the nodal point 12. Preferably, the processor 70 of the device 14 of the preferred embodiment can process the combination of signals indicative of such a movement as a translational shift of the device 14 relative to the nodal point 12 and adapt a virtual parallax of the viewable scene accordingly.

As shown in FIGS. 4I, 4J, and 4K, the processor 70 of the device 14 of the preferred embodiment can be further configured to adjust a virtual perspective of the scene 18 in response to a change in a rotational orientation of the device 14 and the nodal point 12. The processor 70 can preferably function to reorient, reshape, resize, and/or skew one or more aspects 22, 26 of the displayable scene 18 to convey a sense of perspective and/or a non-plan viewing angle of the scene 18 in response to a rotational movement of the device 14 relative to the nodal point 12. As noted above, adjustment of the virtual perspective of the scene is related in part to a distance between one end of the device and the nodal point and a distance between the other end of the device and the nodal point 12. As shown in FIG. 4J, rotation of the device 14 about axis 28 brings one side of the device 14 closer to the nodal point 12 than the other side, while leaving the top and bottom of the device 14 relatively equidistant from the nodal point 12.

As shown in FIG. 4K, preferred adjustment of aspects 22, 26 of the scene to create the virtual perspective will apply both to foreground aspects 22 and background aspects 26. The processor 70 of the preferred embodiment can adjust the virtual perspective of each aspect 22, 26 of the scene 18 in response to at least its position in the scene 18, the degree of rotation of the device 14 relative to the nodal point 12, the relative depth (foreground/background) of the aspect 22, 26, and/or any other suitable metric or visual cue. As noted above and as shown, lines that are parallel in the scene 18 when the device 14 is directed at the nodal point 12 shown in FIG. 41 will converge in some other direction in the display as shown in FIG. 4K as the device 14 is rotated as shown in FIG. 4J.

In another variation of the device 14 of the preferred embodiment, the processor 70 can be configured to reorient, reshape, resize, and/or translate one or more aspects of the displayable scene 18 in response to the detection of actual movement of the nodal point 12. As noted above, the nodal point can include an arbitrary point in real or fictitious space relative to which the scenes 18 described herein are displayable. Accordingly, any movement of the real or fictitious nodal point 12 preferably results in a corresponding adjustment of the displayable scene 18 by the processor 70. In another variation of the device 14 of the preferred embodiment noted above, the nodal point 12 can include a user's head or any suitable portion thereof.

Preferably, one of more portions or modules of the orientation module 50 can detect movement of the nodal point 12 in real space, which movements can be used by the processor 70 creating the corresponding adjustments in the displayable scene 18. The real position of the nodal point 12 can preferably be determined using any suitable combination of devices, including for example one or more cameras (front/rear), an accelerometer, a gyroscope, a MEMS gyroscope, a magnetometer, a pedometer, a proximity sensor, an infrared sensor, an ultrasound sensor and/or any module, portion, or component of the orientation module 50. As an example, a user 12 can wear a pedometer in communication with the device such that when the user walks through real space, such movement of the user/nodal point 12 is translated into movement in the VAR space, resulting in a corresponding adjustment to the displayable scene 18. Alternatively, the location module 60 of the device 14 of the preferred embodiment can determine a position and/or motion of the device 14 in response to a global positioning signal associated with the device 14. Preferably, real and/or or simulated movement of the user/nodal point 12 in space can result in the adjustment of the location of the origin/center/viewing point of the displayable scene 18.

In another variation of the device 14 of the preferred embodiment, the processor 70 can be further configured to display a floating-point exposure of the displayable scene in order to minimize lighting irregularities. As noted above, the displayable scene 18 can be any suitable geometry, including for example a spherical image 20 disposed substantially symmetrically about a nodal point 12 as shown in FIG. 3. Displaying a floating-point exposure preferably functions to allow the user to view/experience the full dynamic range of the image without having to artificially adjust the dynamic range of the image. Preferably, the processor 70 of the preferred embodiment is configured to globally adjust the dynamic range of the image such that a portion of the image in the center of the display is within the dynamic range of the device. As noted above, comparable high dynamic range (HDR) images appear unnatural because they attempt to confine a large image range into a smaller display range through tone mapping, which is not how the image is naturally captured by a digital camera.

As shown in FIG. 3, preferably the processor 70 preserves the natural range of the image 20 by adjusting the range of the image 20 to always fit around (either symmetrically or asymmetrically) the portion of the image 18 viewable in the approximate center of the device's display 40. As noted above, the device 14 of the preferred embodiment can readily adjust one or more aspects of the displayable scene 18 in response to any number of potential inputs relating to the orientation of the device 14 and/or the nodal point 12. Accordingly, the device 14 of the preferred embodiment can further be configured to adjust a floating point exposure of the displayable scene 18 in response to any changes in the displayable scene 18, such as for example adjustments in the virtual zoom, virtual parallax, virtual perspective, and/or virtual origin described in detail above.

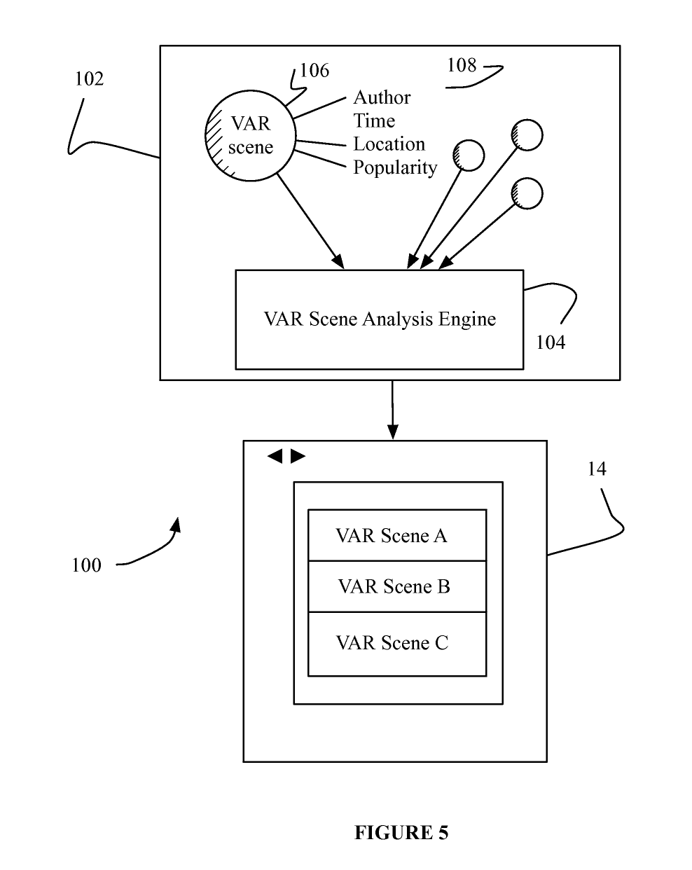

As shown in FIG. 5, the system 100 can further include a server 102 in communication with the viewer device 14. The server 102 preferably functions to retrieve, store, host, categorize, analyze, manage, communicate, and/or distribute one or more VAR scenes 106. As noted above, the server 102 preferably performs these functions within a social network within which there are various entities (e.g., users and viewers), including artificial entities and natural persons, that have social relationships such as friend, follower, like, tweet, check-in, and the like available on common social networking platforms. The server 102 of the preferred system 100 can be configured as a stand-alone server or as any number of networked distributed servers, server clusters, or cloud-based computing platforms. Preferably, some of all of the VAR scenes 106 can be user-generated by a user having a user device 14 of the type described above. Alternatively, some of all of the VAR scenes 106 can be entity-generated by businesses, governments, non-profits, advertising/marketing agencies, web designers, or other associations through which a viewer can connect through a social network.

As shown in FIG. 5, the server 102 of the preferred system 100 can include a VAR scene analysis engine 104. The VAR scene analysis engine 104 preferably functions to retrieve, analyze, categorize, promote, disseminate, select and/or distribute one or more VAR scenes 106 to a viewer device 14 in response to one or more VAR scene parameters 108. As shown in FIG. 5, example VAR scene parameters 108 can include a scene author, a scene time, a scene location, and/or scene popularity. In variations of the preferred system 100, the VAR scene analysis engine 104 organizes and transmits the one or more VAR scenes 106 to the viewer device 14 in the form of a feed or listing of viewable scenes as shown in FIG. 5. Preferably, the VAR scene analysis engine 104 performs this task for any suitable number of viewer devices 14, each of which is configured to view any number of VAR scenes 106, which in turn can include any number of VAR scene parameters 108. Accordingly, the preferred system 100 functions in part to provide each viewer device 14 (and each associated viewer) with access to a feed, listing, or stream of customized VAR scenes 106 for viewing according to the tastes and/or preferences of the viewer and according to the display processes outlined herein.

### 2. Methods

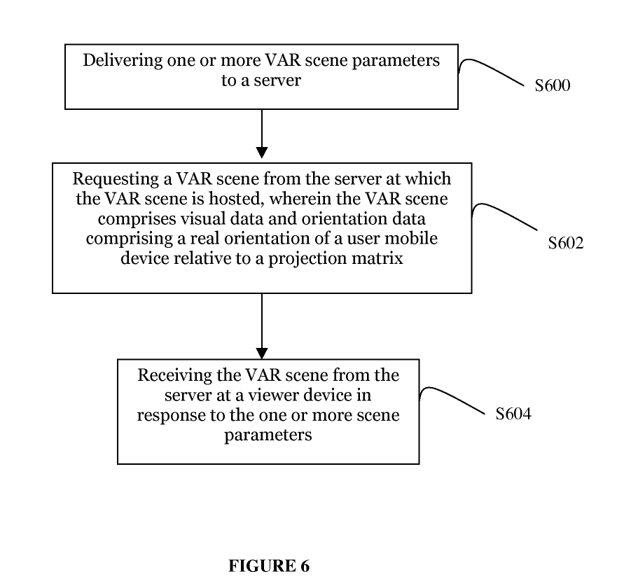

As shown in FIG. 6, a method of the preferred embodiment can include delivering one or more VAR scene parameters to a server in block S600, requesting a VAR scene from the server at which the VAR scene is hosted in block S602, and receiving the VAR scene from the server at a viewer device in response to the one or more scene parameter in block S604. Preferably, the VAR scene can include one or both of visual data and orientation data, and preferably the orientation data can include one or both of a real orientation of a device relative to a projection matrix. The preferred method can function to retrieve, request, receive, promote, and/or display one or more VAR scenes on a viewer device connectable to a social network through a server of the type described above. The preferred method can further function to customize, adjust, generate, and/or promote one or more VAR scenes to a viewer device in response to one or more viewer-related preferences, which can be determined through direct query, through social network interaction, and/or through analysis of viewer behavior. The preferred method can further function to collect, retrieve, request, promote, and/or prompt the generation and/or creation and distribution of VAR scenes by users for distribution and sharing with viewers through a social network.

As shown in FIG. 6, the preferred method recites delivering one or more VAR scene parameters to a server in block S600. Block S600 preferably functions to cause one or more VAR scene parameters indicative of a viewing preference to be directed to, posted to, and/or delivered to the server. The one or more parameters can be directly received from the viewer through his or her viewing device in response to one or more server-side queries and/or positive actions taken by the viewer on the social network. As an example, one or more VAR scene parameters can be deduced or inferred from the viewers social network behaviors, i.e., which other VAR scenes he or she elects to follow, friend, or otherwise intact with inside the social network. Alternatively, the one or more parameters can be indirectly received from the viewer through a viewing history, location history derived for example from the GPS location/s of the viewer device, browser history, stored cookies, browser cache, application use history/purchases, API-exposed viewer behaviors, or any other suitable metric through which viewer preference can be inferred, calculated, estimated, and/or determined. Preferably, the one or more VAR scene parameters can be used by the server in the delivery of one or more VAR scenes to the viewer device as described further below.

As shown in FIG. 6, the preferred method further includes block S602, which recites requesting a VAR scene from the server at which the VAR scene is hosted. Preferably, the VAR scene can include visual data and orientation data; the latter of which can further include a real orientation of a device relative to a projection matrix. Block S602 preferably functions to communicate a request from a viewer device to the server for the server to deliver a VAR scene to the viewer device. Preferably, the VAR scene is generated by a user and/or entity within the viewer's social network as described above. Preferably, the VAR scene can include one or more still images arranged in a substantially spherical format such that the user is photographically capturing a bubble around his or her position. Alternatively, the VAR scene can include any number of still and/or video images in any other suitable format, such as planar, ribbon-like, hemispherical, or any combination thereof. Preferably, the VAR scene is acquired according to the preferred systems or methods disclosed in the inventors' co-pending patent application Ser. No. 13/302,977 entitled “System and Method for Acquiring Virtual and Augmented Reality Scenes by a User,” filed on 22 Nov. 2011 and assignable to the assignee of the present application.

As shown in FIG. 6, the preferred method can further include block S604, which recites receiving the VAR scene from the server at a viewer device in response to the one or more VAR scene parameters. Block S604 preferably functions to generate, transmit, communicate, distribute, return, and/or deliver a selected VAR scene to a viewer device in response to the one or more VAR scene parameters. Preferably, the selected VAR scene is selected at and/or by the server by and/or through a VAR scene analysis engine of the type described above. Preferably, distribution of the VAR scene by and between the user/viewer device and the server is accomplished according to the preferred systems or methods disclosed in the inventors' co-pending patent application Ser. No. 13/347,273 entitled “System and Method for Sharing Virtual and Augmented Reality Scenes Between Users and Viewers,” filed on 10 Jan. 2012 and assignable to the assignee of the present application. In particular, the VAR scene is preferably received at the viewer device in such a manner that the VAR scene includes at least visual data and orientation data so that the VAR scene can be viewed and/or adjusted as described elsewhere herein.

Preferably, the one or more VAR scene parameters can include any combination or sub-combination of: a scene location, a scene date, a scene author, a scene reputation, an author reputation, a scene rating, an author rating, a scene keyword, a scene description, a scene tag, a related scene, a scene path, or any other suitable qualitative or quantitative descriptor of the VAR scene. The one or more VAR scene parameters can be generated by the user at the time of creation of the VAR scene, but can alternatively or additionally be generated and/or updated by the user or viewer on any one of the user device, the server, or the viewer device. For example, users or viewers can apply tags to people, objects, landmarks, and/or locations at any suitable time following VAR scene creation. For example, a quantitative descriptor of a scene location can include a location coordinates, which in turn can be determined by any suitable method described herein such as GPS tracking, cellular network triangulation, and/or Wi-Fi hotspot, LAN, or WAN triangulation. Alternatively, an example quantitative descriptor of the scene location can include a location name, such as Alcatraz Island or Golden Gate Bridge. In another alternative, the scene location can include both coordinate values and name tags, for example to assist in distinguishing between ambiguous terms or portions of larger areas. For example, the descriptor Golden Gate can refer to dozens of potential locations in the San Francisco Bay area, thus one or more coordinate values can be used to more particularly identify the structure, location, or event that is the subject of the VAR scene. Those of skill in the art will appreciate that any suitable mixture of qualitative and quantitative descriptors, definitions, and/or tags can be used for describing any suitable VAR scene parameter, and that the use of the scene location is for illustrative purposes only.

As noted above, the location parameter is preferably a set of coordinates and/or altitude of where the VAR scene was created and/or a set of descriptions such as the name of a business, a street address, or any suitable location description. The date and time are preferably the date and time of when the VAR scene was captured, which can be used in creating a timeline of VAR scenes from the same location or other applications discussed below. The author of a VAR scene can be used to share VAR scenes amongst others that share a social connection or interest in the author. The reputation and rating are parameters that are preferably stored but may be generated through the viewing and use of the VAR scene. Reputation preferably includes the historical popularity of the author, location, or timing of the VAR scene. The reputation can be a metric combining numerous aspects of other parameters. A rating parameter similarly is used as a metric to represent the views of users. Tags, keywords, and descriptions are preferably textual words that can be associated with the VAR scene. Tags, keywords, and descriptions can be author created, viewer created, and/or automatically created. People tags are preferably indicators of people captured or included in the VAR scene. Additionally, a tag for a VAR scene can be generated based on a website where a VAR scene has been embedded or from any suitable source of associated content. Related bubbles can be a mapping to other similar or associated bubbles. The related bubbles can be associated using other parameters. A VAR scene path preferably includes a collection of VAR scenes that can be navigated to form some suitable collection as described below. For example, a VAR scene path may include a series of VAR scenes of popular tourist attractions in a city. VAR scene parameters may be generated on the client side at the time of creation, but may alternatively or additionally be generated or updated later by viewers of the VAR scene, automatically, or through any suitable process. For example, users can apply tags to locations, landmarks, objects, and/or people when viewing the VAR scene.

Another example VAR scene parameter is scene popularity, which functions to create a construct for measuring level of interest in a VAR scene. VAR scene popularity is preferably based on viewing history of the VAR scene, including for example any ratings or reviews received by the VAR scene. This popularity can be a global popularity for all users or any subset thereof, including groups within the social network and/or individual viewers. The popularity parameter can depend on a number of factors such as the number of views of the VAR scene. VAR scenes viewed by more people would have a greater popularity level. Preferably, the popularity of a VAR scene can be weighted as a function of the distance between the VAR scene location and the viewers of the VAR scene. For example, a VAR scene of the Golden Gate Bridge might have views from users all over the country and have a high global popularity, while a VAR scene of a simple local street in San Francisco would not attract as many views by users across the country and thus not have high popularity. Accordingly, the popularity of a VAR scene can be directly proportional to an average distance between its viewers and the location of the VAR scene, thus indicating a greater global appeal of the VAR scene.

In another variation of the preferred method, block S604 can further include receiving a feed including multiple VAR scenes from the server at the viewer device. Preferably, the feed is generated at the server in accordance with the viewer's predetermined VAR scene parameters, which in turn can be determined according to any of the methods described above. In particular, preferably the feed can include one or more VAR scenes that fall within the VAR scene parameters and are related (by user, entity, or parameter) the viewer's social network. Accordingly, the feed can include VAR scenes from the viewer's friends and followers as well as VAR scenes related to locations, landmarks, and/or events associated with the viewer's network or in which the viewer has expressed a direct or indirect interest or liking.

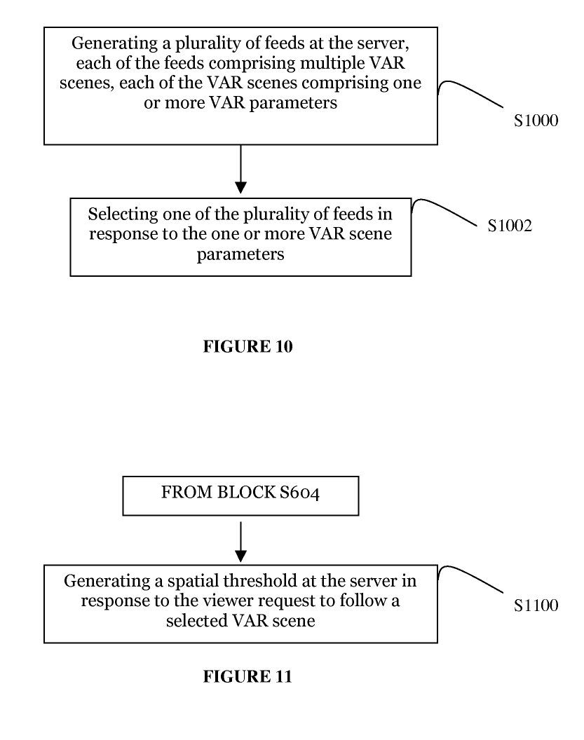

As shown in FIG. 10, another variation of the preferred method can include generating a plurality of feeds at the server in block S1000; and selecting one of the plurality of feeds in response to the one or more VAR scene parameters in block S1002. Each of the feeds preferably includes multiple VAR scenes, and each of the VAR scenes preferably includes one or more VAR scene parameters. Blocks S1000 and S1002 preferably function to aggregate, categorize, delineate, coordinate, generate and/or select a feed out of the innumerable potential feeds that can and are generated by the cross-section of a viewer's social network and the one or more VAR scene parameters in which the viewer has an interest. As noted above, the feed can include multiple VAR scenes distributable to each viewer device. Preferably, within a feed, the multiple VAR scenes can be ordered in any suitable order, including for example: a time of recommendation, a time of addition to the feed, a time of capture, or a viewer request. In another variation of the preferred method, the viewer request can include an affirmative instruction from the viewer device to follow, like, friend, or otherwise select a desired VAR scene such that the feed includes at least some VAR scenes that are not generated according to a matching or correlation of VAR parameters within the viewer's social network.

As shown in FIG. 11, another variation of the preferred method can include generating a spatial threshold at the server in response to the viewer request to follow a selected VAR scene in block S1100. Block S1100 preferably functions to generate, delineate, calculate, and/or determine a spatial area, distance, range, perimeter, proximity, or relationship between the selected VAR scene and any one or more ancillary VAR scenes at or near the location of the selected VAR scene. Preferably, block S1100 further functions to locate, populate, and/or suggest additional potential VAR scenes for the feed and/or for delivery to the viewer device in response to their being within the spatial threshold. Preferably, a location within the spatial threshold can be includes as an additional VAR scene parameter to assist the server in generating VAR scenes for distribution to the viewer device. As an example, if the viewer selects a VAR scene located at Alcatraz Island, then the predetermined spatial threshold might suggest additional and/or alternative VAR scenes for viewing in the proximity of Alcatraz Island, such as Fisherman's Wharf, Pier 39, the Presidio, Fort Mason, and/or other nearby San Francisco locales. Preferably, the relative size of the spatial threshold is inversely proportional to the density of VAR scenes within a nominal spatial threshold (i.e., a unit threshold). Thus, for heavily trafficked areas such as New York City, San Francisco, Tokyo and the like, the spatial threshold can be relatively smaller in size and scope so as to not overcrowd the feed generated for the viewer. Conversely, for lightly trafficked areas such as Mount Denali or Death Valley, the relative size of the spatial threshold can be larger so as to encompass additional VAR scenes that are spatially related or subject matter related to the selected VAR scene. Preferably, the relative size and/or scope of the spatial threshold is adjustable on or at the server in response to the overall population of VAR scenes having the applicable location parameter satisfied.

In another variation of the preferred method, one of the VAR scene parameters can include a scene path, which can include either a series of linked VAR scenes distributed in space, or a single ribbon-like VAR scene along a continuous or quasi-continuous linear trail. In one alternative, serial VAR scenes can be linked together by a user and/or scene generator to create the scene path. In another alternative, the scene path can be generated and/or created at the server by linking two or more discrete VAR scenes from one or more users together into the scene path. In the latter alternative, the server can preferably employ one or more scene parameters (e.g., location, time, keyword/s) associated with the discrete VAR scenes in deciding whether and how to integrate the VAR scenes into a unitary scene path.

Preferably, a user-generated scene path can be generated in response to a user request made on and/or through his or her user device in capturing the two or more discrete scene paths. For example, the user can manually integrate the two or more scenes together on his or her user device. Alternatively, the user can select a VAR scene path mode, in which a resident application on the user device automatically integrates the two or more scenes together on the user device. In another alternative, the user can interact with the server (through the user device or any other suitable computing platform) to cause the server to integrate the two or more scenes together by and/or at the server.

In another alternative embodiment of the preferred method, the scene path can be generated automatically by the user device. Preferably, as noted above, the user device can include a location module configured to determine a location of the user device through at least one of global satellite positioning (e.g., GPS), cellular network triangulation, and/or Wi-Fi, WAN, LAN triangulation. The user device can also preferably include one or more APIs adapted to expose any suitable location information such that the capture of any or all VAR scenes is associated with a particular location and/or set of location coordinates. Accordingly, operation of the user device can alternatively include continuous or quasi-continuous generation of location-based data that can be used by one of the user device, the server, and/or the viewer device in assembling a VAR scene path from a series of discrete VAR scenes associated with location data generated automatically by the user device. Preferably, the user device can be further configured to prompt a user before, during, and/or following the capture of a VAR scene whether the user wants to integrate the captured VAR scene into a VAR scene path. Alternatively, the preferred method can include providing a user with the option to capture a VAR scene path, wherein the user device provides the path/scene locations through the acquisition of the user device location data as described above.

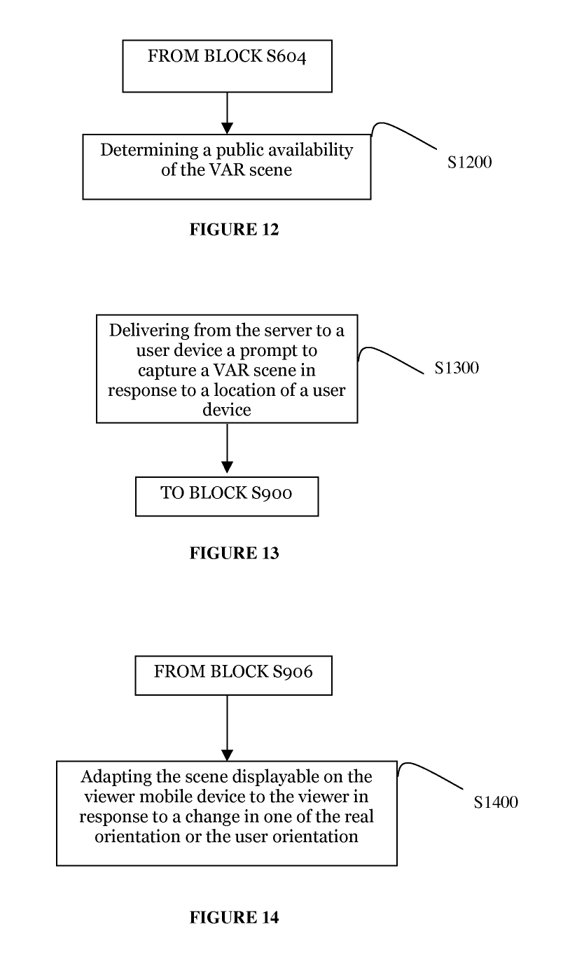

As shown in FIG. 12, another variation of the preferred method can include determining a public availability of the VAR scene in block S1200. Block S1200 preferably functions to automatically determine a public nature and/or privacy setting of a VAR scene. The option to manually set privacy settings can be enabled through the VAR scene social network, but the privacy of a VAR scene can be assessed and used in determining which VAR scenes to deliver to a viewer device. Block 1200 can further include comparing location information to known public locations such as stores or public attractions. As an additional step, the setting of a VAR scene may be analyzed to determine if the VAR scene is outside or inside. One suitable technique for determining whether a scene is indoors or outdoors uses compass data, geolocation information, time of day, and sun location data to determine if the sun is visible in the expected location. Other triggers can additionally be used such as shadows, indoor lighting characteristics, or any suitable element. Indoor VAR scenes are preferably labeled as private VAR scenes. Additionally, facial recognition algorithms can be used to determine if people are prominently portrayed in the VAR scene. If people are prominently portrayed then the VAR scene can be considered more private and only shared with viewers sharing a social network connection to the captured people. Such privacy factors can additionally be analyzed in combination to determine an overall privacy level for the VAR scene. Preferably private VAR scenes are not shared and/or have location information obscured or concealed.

As shown in FIG. 13, another variation of the preferred method can include delivering from the server to a user device a prompt to capture a VAR scene in response to a location of a user device in block S1300. Block S1300 preferably functions to manage and optimize the creation and/or capture of VAR scenes and/or VAR scene paths through selective prompts of a user to create and/or capture a predetermined VAR scene. Preferably, block S1300 can be performed in response to a proximity of the user device relative to an ideal location. Ideal locations are preferably calculated and/or determined at the server. Parameters of this calculation can include areas of interest to the user, areas of interest to friends/followers of the user, or areas of interest to the social network population at large. These ideal locations are typically locations that currently lack any near by VAR scenes, contain poor quality or unpopular VAR scenes, or may need updated or variety for a VAR scene (e.g., night time and daytime VAR scenes). The location of the user is preferably periodically checked either through the location module of the user device, or through any suitable secondary service social service that offers location check-ins or monitoring. When the location of a user is at or near an ideal location, a prompt is preferably sent to from the server to the user device to capture a VAR scene. Qualifications for the VAR scene can additionally be included in the prompt such as “capture a VAR scene in front of the Statue of Liberty” or “capture a VAR scene at night”. For example, a user may have a friend who enjoys skiing; when the user goes on a ski trip and is on the mountain, a push notification can be sent to the user indicating now would be a good time to capture a VAR scene. This VAR scene can then be shared back to the friend/viewer of the user.

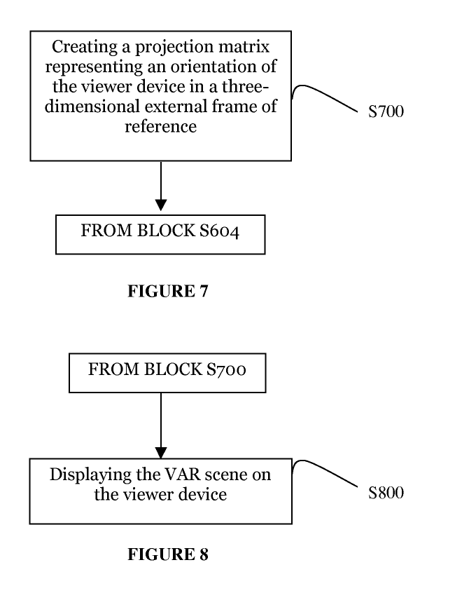

As shown in FIG. 7, another variation of the preferred method can include creating a projection matrix representing an orientation of the viewer device in a three-dimensional external frame of reference in block S700. Block S700 preferably functions to coordinate the displayable scene with a physical orientation of the viewer device as established by and/or relative to a viewer. As noted above, the projection matrix preferably includes a mathematical representation of an arbitrary orientation of a three-dimensional object having three degrees of freedom relative to the external frame of reference. In one variation of the preferred method, the external frame of reference can include a three-dimensional external frame of reference (i.e., real space) in which the gravitational force defines baseline directionality for the relevant coordinate system against which the absolute orientation of the viewer device can be measured. Alternatively, the external frame of reference can include a fictitious external frame of reference, i.e., such as that encountered in a film or novel, whereby any suitable metrics and/or geometries can apply for navigating the device through the pertinent orientations. One example of a fictitious external frame of reference can include a fictitious space station frame of reference, wherein there is little to no gravitational force to provide the baseline directionality noted above. In such an example implementation, the external frame of reference can be fitted or configured consistently with the other features of the VAR scene.

As shown in FIG. 8, another variation of the preferred method can include displaying the VAR scene on the viewer device in block S800. Block S800 preferably functions to render, present, project, image, and/or display viewable content on, in, or by a viewer device of the type described herein. Preferably, the displayable scene can include a spherical image of a space having virtual and/or augmented reality components. In one variation of the preferred method, the spherical image displayable on the device can be substantially symmetrically disposed about the nodal point, i.e. the nodal point is substantially coincident with and/or functions as an origin of a spheroid upon which the image is rendered as described above with reference to FIG. 3.

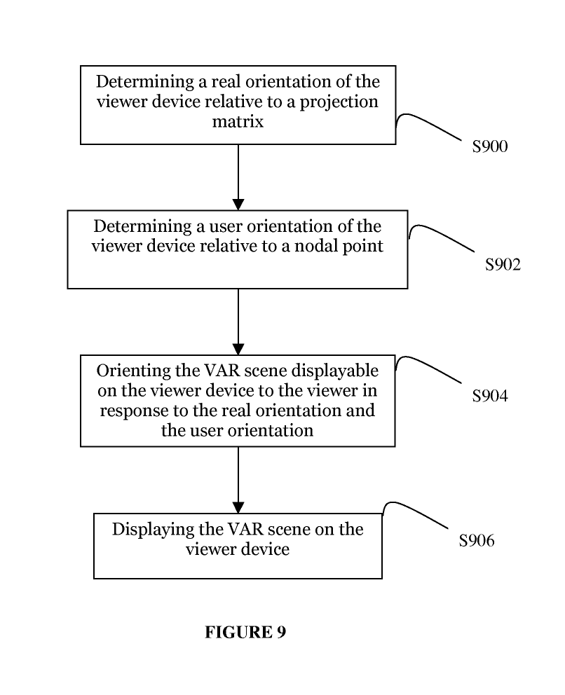

As shown in FIG. 9, another variation of the preferred method can include determining a real orientation of the viewer device relative to a projection matrix in block S900; determining a user orientation of the viewer device relative to a nodal point in block S902; orienting a scene displayable on the viewer device to the user in response to the real orientation and the user orientation in block S904; and displaying the VAR scene on the viewer device in block S906. Block S900 preferably functions to provide a frame of reference for the viewer device as it relates to a world around it, wherein the world around can include real three-dimensional space, a virtual reality space, an augmented reality space, or any suitable combination thereof. Preferably, the projection matrix can include a mathematical representation of an arbitrary orientation of a three-dimensional object having three degrees of freedom relative to a second frame of reference. As an example, the projection matrix can include a mathematical representation of a viewer device's orientation in terms of its Euler angles (pitch, roll, yaw) in any suitable coordinate system. In one variation of the third preferred method, the second frame of reference can include a three-dimensional external frame of reference (i.e., real space) in which the gravitational force defines baseline directionality for the relevant coordinate system against which the absolute orientation of the viewer device can be measured. Preferably, the real orientation of the viewer device can include an orientation of the viewer device relative to the second frame of reference, which as noted above can include a real three-dimensional frame of reference. In such an example implementation, the viewer device will have certain orientations corresponding to real world orientations, such as up and down, and further such that the viewer device can be rolled, pitched, and/or yawed within the external frame of reference.

As shown in FIG. 9, the preferred method can further include block S902, which recites determining a user orientation of the viewer device relative to a nodal point. Block S902 preferably functions to provide a frame of reference for the viewer device relative to a point or object in space, including a point or object in real space. Preferably, the user orientation can include a measurement of a distance and/or rotational value/s of the viewer device relative to the nodal point. In another variation of the method of the preferred embodiment, the nodal point can include a viewer's head such that the user orientation includes a measurement of the relative distance and/or rotational value/s of the viewer device relative to a viewer's field of view. Alternatively, the nodal point can include a portion of the viewer's head, such as for example a point between the viewer's eyes. In another alternative, the nodal point can include any other suitable point in space, including for example any arbitrary point such as an inanimate object, a group of users, a landmark, a location, a waypoint, a predetermined coordinate, and the like. Preferably, the user orientation functions to create a viewing relationship between a viewer (optionally located at the nodal point) and the viewer device, such that a change in user orientation can cause a consummate change in viewable content consistent with the viewer's VAR interaction, i.e., such that the viewer's view through the frame of the viewer device will be adjusted consistent with the viewer's orientation relative to the frame of the viewer device.

As shown in FIG. 9, the preferred method can further include block S904, which recites orienting the VAR scene displayable on the viewer device to a user in response to the real orientation and the user orientation. Block S904 preferably functions to process, compute, calculate, determine, and/or create a VAR scene that can be displayed on the viewer device to a user, wherein the VAR scene is oriented to mimic the effect of the viewer viewing the VAR scene as if through the frame of the viewer device. Preferably, orienting the scene can include preparing a VAR scene for display such that the viewable scene matches what the viewer would view in a real three-dimensional view, that is, such that the displayable scene provides a simulation of real viewable space to the viewer as if the device were a transparent frame. Preferably, the VAR scene can include one or more virtual and/or augmented reality elements composing, in addition to, and/or in lieu of one or more real elements (buildings, roads, landmarks, and the like, either real or fictitious). Alternatively, the VAR scene can include processed or unprocessed images/videos/multimedia files of a multitude of scene aspects, including both actual and fictitious elements as noted above.

As shown in FIG. 9, the preferred method can further include block S906, which recites displaying the scene on the viewer device. Block S906 preferably functions to render, present, project, image, and/or display viewable content on, in, or by a viewer device of the type described herein. Preferably, block S906 is performed substantially identically to block S800 described above.

As shown in FIG. 14, another variation of the preferred method can include block S1400, which recites adapting the scene displayable on the viewer device to the user in response to a change in one of the real orientation or the user orientation. Block S1400 preferably functions to alter, change, reconfigure, recompute, regenerate, and/or adapt the displayable scene in response to a change in the real orientation or the user orientation. Additionally, block S1400 preferably functions to create a uniform and immersive viewer experience by adapting the displayable scene consistent with movement of the viewer device relative to the projection matrix and/or relative to the nodal point. Preferably, adapting the displayable scene can include at least one of adjusting a virtual zoom of the scene, adjusting a virtual parallax of the scene, adjusting a virtual perspective of the scene, and/or adjusting a virtual origin of the scene. Alternatively, adapting the displayable scene can include any suitable combination of the foregoing, performed substantially serially or substantially simultaneously, in response to a timing of any determined changes in one or both of the real orientation or the user orientation.

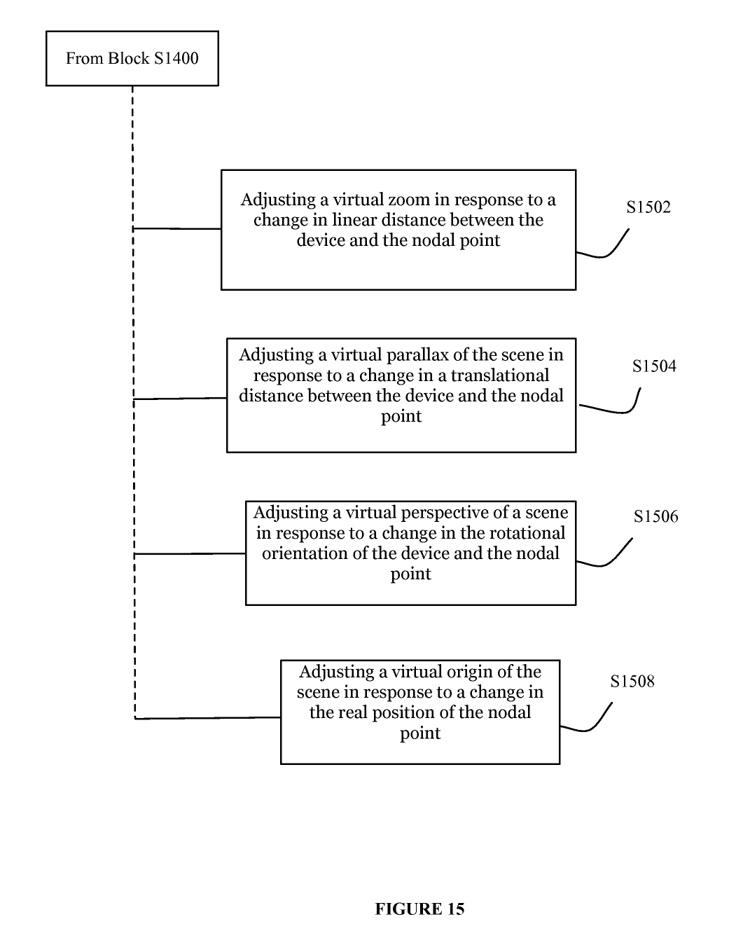

As shown in FIG. 15, another variation of the preferred method can include block S1502, which recites adjusting a virtual zoom of the scene in response to a change in a linear distance between the device and the nodal point. Block S1502 preferably functions to resize one or more displayable aspects of the scene in response to a distance between the device and the nodal point to mimic a change in the viewing distance of the one or more aspects of the scene. As noted above, the nodal point can preferably be coincident with a user's head, such that a distance between the device and the nodal point correlates substantially directly with a distance between a user's eyes and the device. Accordingly, adjusting a virtual zoom can function in part to make displayable aspects of the scene relatively larger in response to a decrease in distance between the device and the nodal point; and to make displayable aspects of the scene relatively smaller in response to an increase in distance between the device and the nodal point. Another variation of the preferred method can include measuring a distance between the device and the nodal point, which can include for example using a front facing camera to measure the relative size of the nodal point (i.e., the user's head) in order to calculate the distance. Alternatively, the adjustment of the virtual zoom can be proportional to a real zoom (i.e., a real relative sizing) of the nodal point (i.e., the user's head) as captured by the device camera. Accordingly, as the distance decreases/increases, the size of the user's head will appear to increase/decrease, and the adjustment in the zoom can be linearly and/or non-linearly proportional to the resultant increase/decrease imaged by the camera. Alternatively, the distance between the nodal point and the device can be measured and/or inferred from any other suitable sensor and/or metric, including at least those usable by the device in determining the projection matrix as described below, including for example one or more cameras (front/rear), an accelerometer, a gyroscope, a MEMS gyroscope, a magnetometer, a pedometer, a proximity sensor, an infrared sensor, an ultrasound sensor, and/or any suitable combination thereof.

As shown in FIG. 15, another variation of the preferred method can include block S1504, which recites adjusting a virtual parallax of the scene in response to a change in a translational distance between the device and the nodal point. Block S1504 preferably functions to reorient the relative size and/or placement of one or more aspects of the displayable scene in response to a translational movement between the device and the nodal point. A translational movement can include for example a relative movement between the nodal point and the device in or along a direction substantially perpendicular to a line of sight from the nodal point, i.e., substantially tangential to an imaginary circle having the nodal point as its origin. As noted above, the nodal point can preferably be coincident with a user's head, such that the translational distance between the device and the nodal point correlates substantially directly with a distance between a user's eyes and the device. Accordingly, adjusting a virtual parallax can function in part to adjust a positioning of certain displayable aspects of the scene relative to other displayable aspects of the scene. In particular, adjusting a virtual parallax preferably causes one or more foreground aspects of the displayable scene to move relative to one or more background aspects of the displayable scene. Another variation of the preferred method can include identifying one or more foreground aspects of the displayable scene and/or identifying one or more background aspects of the displayable scene. Preferably, the one or more foreground aspects of the displayable scene are movable with respect to the one or more background aspects of the displayable scene such that, in block S1504, the preferred method can create and/or adjust a virtual parallax viewing experience for a user in response to a change in the translational distance between the device and the nodal point.

Another variation of the preferred method can include measuring a translational distance between the device and the nodal point, which can include for example using a front facing camera to measure the relative size and/or location of the nodal point (i.e., the user's head) in order to calculate the translational distance. Alternatively, the translational distance between the nodal point and the device can be measured and/or inferred from any other suitable sensor and/or metric, including at least those usable by the device in determining the projection matrix as described below, including for example one or more cameras (front/rear), an accelerometer, a gyroscope, a MEMS gyroscope, a magnetometer, a pedometer, a proximity sensor, an infrared sensor, an ultrasound sensor, and/or any suitable combination thereof. Preferably, the translational distance can be measured by a combination of the size of the nodal point (from the front facing camera) and a detection of a planar translation of the device in a direction substantially orthogonal to the direction of the camera, thus indicating a translational movement without any corrective rotation. For example, one or more of the foregoing sensors can determine that the device is moved in a direction substantially orthogonal to the camera direction (tangential to the imaginary sphere surrounding the nodal point), while also determining that there is no rotation of the device (such that the camera is directed radially inwards towards the nodal point). Preferably, the preferred method can treat such a movement as translational in nature and adapt a virtual parallax of the viewable scene accordingly.

As shown in FIG. 15, another variation of the preferred method can include block S1506, which recites adjusting a virtual perspective of the scene in response to a change in a rotational orientation of the device and the nodal point. Block S1506 preferably functions to reorient, reshape, resize, and/or skew one or more aspects of the displayable scene to convey a sense of perspective and/or a non-plan viewing angle of the scene in response to a rotational movement of the device relative to the nodal point. Preferably, adjustment of the virtual perspective of the scene is related in part to a distance between one end of the device and the nodal point and a distance between the other end of the device and the nodal point. As an example, if a left/top side of the device is closer to the nodal point then the right/bottom side of the device, then aspects of the left/top portion of the scene should be adapted to appear relatively closer (i.e., displayable larger) than aspects of the right/bottom portion of the scene. Preferably, adjustment of the aspects of the scene to create the virtual perspective will apply both to foreground aspects and background aspects, such that the preferred method adjusts the virtual perspective of each aspect of the scene in response to at least its position in the scene, the degree of rotation of the device relative to the nodal point, the relative depth (foreground/background) of the aspect, and/or any other suitable metric or visual cue. As an example, lines that are parallel in the scene when the device is directed at the nodal point (all edges equidistant from the nodal point) will converge in some other direction in the display (i.e., to the left, right, top, bottom, diagonal, etc.) as the device is rotated. Preferably, if the device is rotated such that the left edge is closer to the nodal point than the right edge, then formerly parallel lines can be adjusted to converge towards infinity past the right edge of the device, thus conveying a sense of perspective to the user.

Another variation of the preferred method can include measuring a rotational orientation between the device and the nodal point, which can include for example using a front facing camera to measure the relative position of the nodal point (i.e., the user's head) in order to calculate the rotational orientation. Alternatively, the rotational orientation of the nodal point and the device can be measured and/or inferred from any other suitable sensor and/or metric, including at least those usable by the device in determining the projection matrix as described below, including for example one or more cameras (front/rear), an accelerometer, a gyroscope, a MEMS gyroscope, a magnetometer, a pedometer, a proximity sensor, an infrared sensor, an ultrasound sensor, and/or any suitable combination thereof. Preferably, the rotational orientation can be measured by a combination of the position of the nodal point (as detected by the front facing camera) and a detection of a rotation of the device that shifts the direction of the camera relative to the nodal point. As an example, a front facing camera can be used to determine a rotation of the device by detecting a movement of the nodal point within the field of view of the camera (indicating that the device/camera is being rotated in an opposite direction). Accordingly, if the nodal point moves to the bottom/right of the camera field of view, then the preferred method can determine that the device is being rotated in a direction towards the top/left of the camera field of view. In response to such a rotational orientation, the preferred method preferably mirrors, adjusts, rotates, and/or skews the viewable scene to match the displaced perspective that the device itself views through the front facing camera.

As shown in FIG. 15, another variation of the preferred method can include block S1508, which recites adjusting a virtual origin of the scene in response to a change in a real position of the nodal point. Block S1508 preferably functions to reorient, reshape, resize, and/or translate one or more aspects of the displayable scene in response to the detection of actual movement of the nodal point. In one variation of the preferred method, the nodal point can include an arbitrary point in real or fictitious space relative to which the scenes described herein are displayable. Accordingly, any movement of the real or fictitious nodal point preferably results in a corresponding adjustment of the displayable scene. In another variation of the preferred method, the nodal point can include a user's head or any suitable portion thereof. In such an implementation, movement of the user in real space can preferably be detected and used for creating the corresponding adjustments in the displayable scene. The real position of the nodal point can preferably be determined using any suitable combination of devices, including for example one or more cameras (front/rear), an accelerometer, a gyroscope, a MEMS gyroscope, a magnetometer, a pedometer, a proximity sensor, an infrared sensor, and/or an ultrasound sensor. As an example, a user can wear a pedometer in communication with the device such that when the user walks through real space, such movement of the user/nodal point is translated into movement in the VAR space, resulting in a corresponding adjustment to the displayable scene. Another variation of the preferred method can include determining a position and/or motion of the device in response to location service signal associated with the device. Example location service signals can include global positioning signals and/or transmission or pilot signals transmittable by the device in attempting to connect to an external network, such as a mobile phone or Wi-Fi type wireless network. Preferably, the real movement of the user/nodal point in space can result in the adjustment of the location of the origin/center/viewing point of the displayable scene.

The user and viewer devices 14 and methods of the preferred embodiment can be embodied and/or implemented at least in part as a machine configured to receive a computer-readable medium storing computer-readable instructions. The instructions are preferably executed by computer-executable components preferably integrated with the user/viewer device 14 and one or more portions of the processor 70, orientation module 50 and/or location module 60. Other systems and methods of the preferred embodiment can be embodied and/or implemented at least in part as a machine configured to receive a computer-readable medium storing computer-readable instructions. The instructions are preferably executed by computer-executable components preferably integrated by computer-executable components preferably integrated with a user/viewer device 14 or a server 102 of the type described above. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention defined in the following claims.

What is claimed is:

1. A method comprising:
delivering a VAR scene parameter to a server;
requesting a VAR scene from the server at which the VAR scene is hosted, wherein the VAR scene comprises visual data and orientation data comprising a real orientation of a device relative to a projection matrix;
receiving the VAR scene from the server at a viewer device in response to the VAR scene parameter.

2. The method of claim 1, wherein the VAR scene parameter comprises one of: a scene location, a scene date, a scene author, a scene reputation, an author reputation, a scene rating, an author rating, a scene keyword, a scene description, a scene tag, a related scene, and a scene path.

3. The method of claim 2, wherein the scene location comprises a location coordinates.

4. The method of claim 2, wherein the scene location comprises a location name.

5. The method of claim 1, wherein the viewer device is associated with a viewer, and wherein the viewer shares a social network connection with the user.

6. The method of claim 5, wherein the user comprises one of a natural person or an artificial entity.

7. The method of claim 1, wherein receiving the VAR scene from the server at the viewer device comprises receiving a feed comprising multiple VAR scenes from the server at the viewer device.

8. The method of claim 7, wherein receiving the VAR scene from the server at the viewer device further comprises:
generating a plurality of feeds at the server, each of the feeds comprising multiple VAR scenes, each of the VAR scenes comprising one or more VAR scene parameters; and
selecting one of the plurality of feeds in response to the one or more VAR scene parameters.

9. The method of claim 7, wherein the feed comprises multiple VAR scenes ordered by one of: a time of recommendation, a time of addition to the feed, a time of capture, or a viewer request.

10. The method of claim 9, wherein the viewer request comprises a viewer instruction to follow a selected VAR scene.

11. The method of claim 10, further comprising: generating a spatial threshold at the server in response to the viewer request to follow a selected VAR scene.

12. The method of claim 1, wherein the VAR scene parameter comprises a location within a spatial threshold.

13. The method of claim 1, wherein the VAR scene parameter comprises a scene path.

14. The method of claim 13, wherein the scene path is generated in response to a user request.

15. The method of claim 15, wherein the scene path is generated automatically by the user device.

16. The method of claim 1, further comprising determining a public availability of the VAR scene.

17. The method of claim 1, further comprising delivering from the server to a user device a prompt to capture a VAR scene in response to a location of a user device.

18. The method of claim 1, wherein the VAR scene parameters comprises a scene popularity.

19. The method of claim 1, further comprising displaying the VAR scene on the viewer device.

20. The method of claim 19, wherein displaying the VAR scene on the viewer device comprises:
determining a real orientation of the viewer device relative to a projection matrix;
determining a user orientation of the viewer device relative to a nodal point;
orienting a scene displayable on the viewer device to the user in response to the real orientation and the user orientation; and
displaying the VAR scene on the viewer device.

21. The method of claim 20, further comprising creating a projection matrix representing an orientation of the viewer device in a three-dimensional external frame of reference.

22. The method of claim 20, further comprising adapting the scene displayable on the viewer device to the user in response to a change in one of the real orientation or the user orientation.
